(19) United States
(12) Patent Application Publication
(10) Pub. No.: US 2024/0003372 A1
(43) Pub. Date: Jan. 4, 2024

(54) DEFORMABLE FASTENER

(71) Applicant: C-FLEX BEARING CO., INC., Frankfort, NY (US)

(72) Inventor: Wayne A. SMITH, Holland Patent, NY (US)

(73) Assignee: C-FLEX BEARING CO., INC., Frankfort, NY (US)

(21) Appl. No.: 17/856,211

(22) Filed: Jul. 1, 2022

(51) Int. Cl. F16B 19/10

(52) U.S. Cl. CPC F16B 19/10

(57) ABSTRACT

There is set forth herein, according to one embodiment: a fastener having an extended section that includes a deformable distal end; a joining body having a through hole configured so that the extended section can be fitted through the through hole; wherein the fastener is configured so that with the joining body joined to the fastener, the deformable distal end can be deformed to increase a holding force between the joining body and the fastener. There is set forth herein, according to one embodiment: a fastener comprising a head and an extended section extending from the head, wherein the extended section includes a deformable distal; wherein the deformable distal end is defined by a circumferential sidewall that forms a counterbore.

### BACKGROUND

Embodiments herein relate to fasteners and specifically to a deformable fastener.

Fastening methods can include use of a variety of fasteners including, e.g., screws, bolts, nuts, rivets, as well as various methods for restricting movement of secured components. Some of these techniques include use of lock washers, castellated nuts with wire or cotter pin locks, or thread locking liquids.

### BRIEF SUMMARY OF THE INVENTION

There is set forth herein according to one embodiment: A fastener assembly comprising a fastener having an extended section that includes a deformable distal end; a joining body having a through hole configured so that the extended section can be fitted through the through hole; wherein the fastener is configured so that with the joining body joined to the fastener, the deformable distal end can be deformed to increase a holding force between the joining body and the fastener.

There is set forth herein according to one embodiment: A method comprising fitting a through hole of a joining body over an extended section of a fastener that includes a head and the extended section, wherein the extended section includes a deformable distal end; and with the joining body fitted over the extended section, deforming the deformable distal end to increase a holding force between the joining body and the fastener.

There is set forth herein according to one embodiment: A fastener assembly comprising a fastener including a head and a threaded extended section that includes a deformable distal end defined by a circumferential sidewall that forms a counterbore, wherein the head, the threaded extended section and the circumferential sidewall are symmetrically formed about a longitudinal central axis of the fastener; a joining body having a threaded through hole configured so that the threaded through hole can be threaded onto the threaded extended section of the fastener; wherein the fastener is configured so that with the joining body joined to the fastener, the circumferential sidewall can be deformed to increase a holding force between the joining body and the fastener.

There is set forth herein according to one embodiment: A fastener comprising a head and an extended section extending from the head, wherein the extended section includes a deformable distal; wherein the deformable distal end is defined by a circumferential sidewall that forms a counterbore.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

Reference will be made in detail to the preferred embodiment of the invention, examples of which are illustrated in the accompanying drawing figures. The figures are intended to be illustrative, not limiting. Although the invention is generally described in the context of this preferred embodiment, it should be understood that it is not intended to limit the scope of this invention to this particular embodiment.

Certain elements in selected views of the drawings may be illustrated not-to-scale for illustrative clarity. Elements of the figures can be numbered such that similar (including identical) elements may be referred to with similar numbers in a single drawing.

The structure, operation, and advantages of the present preferred embodiment of the invention will become further apparent upon consideration of the following description taken in conjunction with the accompanying drawings, wherein:

FIG. 1 is a side view of a fastener assembly according to one embodiment;

FIG. 2 is a cutaway side view of the fastener assembly as shown in FIG. 1 according to one embodiment;

FIG. 3 is a cutaway side view of a fastener according to one embodiment;

FIG. 4 is a cutaway side view of a joining body for joining with a fastener according to one embodiment;

FIG. 5 is an isometric exploded assembly view of a fastener assembly according to one embodiment;

FIG. 6 is a cross-sectional side view of a fastener assembly in an intermediary fastening stage according to one embodiment;

FIG. 7 is a fastener according to one embodiment;

FIG. 8 is a cross-sectional side view of a joining body according to one embodiment;

FIG. 9 is a cross-sectional side view of fastener assembly in an intermediary fastening stage according to one embodiment;

FIG. 10 is a cross-sectional side view of fastener assembly in a fastened stage according to one embodiment;

FIG. 11 is an isometric exploded assembly view of the fastener assembly according to one embodiment;

FIG. 12 is an isometric view of a fastener assembly in a fastened stage according to one embodiment;

FIG. 13 is a front view of a joining body according to one embodiment;

FIG. 14 is an isometric view of joining body of FIG. 13 according to one embodiment;

FIG. 15 is an isometric view depicting a conical punch for use in deforming a distal end of a fastener according to one embodiment.

### DETAILED DESCRIPTION

The accompanying figures, in which like reference numerals refer to identical or functionally similar elements throughout the separate views and which are incorporated in and form a part of the specification, further illustrate the present implementation(s) and, together with the detailed description of the implementation(s), serve to explain the principles of the present implementation(s). As understood by one of skill in the art, the accompanying figures are provided for ease of understanding and illustrate aspects of certain examples of the present implementation(s). The implementation(s) is/are not limited to the examples depicted in the figures.

The terms “connect,” “connected,” “contact,” “coupled,” and/or the like are broadly defined herein to encompass a variety of divergent arrangements and assembly techniques. These arrangements and techniques include, but are not limited to, (1) the direct joining of one component and another component with no intervening components therebetween (i.e., the components are in direct physical contact); and (2) the joining of one component and another component with one or more components therebetween, provided that the one component being “connected to” or “contacting” or “coupled to” the other component is somehow in operative communication (e.g., electrically, fluidly, physically, optically, etc.) with the other component (notwithstanding the presence of one or more additional components therebetween). It is to be understood that some components that are in direct physical contact with one another may or may not be in electrical contact and/or fluid contact with one another. Moreover, two components that are electrically connected, electrically coupled, optically connected, optically coupled, fluidly connected, or fluidly coupled may or may not be in direct physical contact, and one or more other components may be positioned therebetween.

The terms “substantially,” “approximately,” “about,” “relatively,” or other such similar terms that may be used throughout this disclosure, including the claims, are used to describe and account for small fluctuations, such as due to variations in processing, from a reference or parameter. Such small fluctuations include a zero fluctuation from the reference or parameter as well. For example, they can refer to less than or equal to ±10%, such as less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. If used herein, the terms “substantially,” “approximately,” “about,” “relatively,” or other such similar terms may also refer to no fluctuations, that is, ±0%.

Embodiments herein recognize that fasteners, used for joining a wide variety of two or more components together. are offered in a wide variety of head shapes and sizes, body lengths and diameters, and shapes.

Embodiments herein recognize that threaded fasteners, used for joining a wide variety of two or more components together are offered in a wide variety of head shapes and sizes, threaded body lengths and diameters, and thread shapes. Two basic types of fastening are used by these prior art fasteners. The first utilizes a threaded nut, which is assembled and tightened onto the threaded fastener after the threaded fastener has been assembled into and through the items to be clamped. The components to be clamped are thereby clamped between the threaded fastener head and the threaded nut. The second utilizes a component with an internal thread suitable to receive and interface with the threaded fastener. In this design, the threaded fastener is assembled into and through the components to be clamped and into the component with the internal thread. The threaded fastener is then tightened into the component with the internal thread, thereby clamping the components to be clamped between the threaded fastener head and the component with the internal thread.

Embodiments herein recognize that in order to maintain the clamping forces necessary to keep a tight interface between the components to be clamped, various types of techniques are utilized to prevent the threaded components from rotating relative to each other which could cause the clamping forces to be reduced or loosened. Some of these techniques would include lock washers, castellated nuts with wire or cotter pin locks, or thread locking liquids. Embodiments herein can provide an unthreaded or threaded fastener which is economical to produce, while still having the capability of achieving a non-threaded or threaded connection which is resistant to loosening.

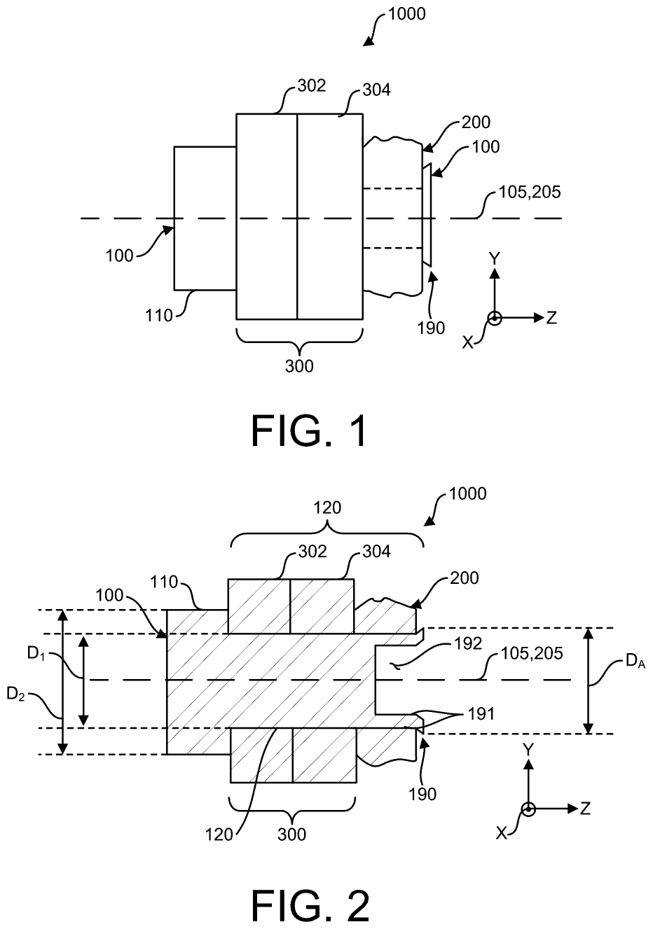

FIG. 1 is a side view illustrating an embodiment of fastener assembly 1000 including fastener 100 and joining body 200 joined to the fastener 100. Fastener assembly 1000 can be used to join zero or more secured members 300. In FIG. 1, secured members 300 can include first member 302 and second member 304. FIG. 1 depicts fastener assembly 1000 in a secured state with fastener 100 in a deformed state. In a deformed state as shown in FIG. 1, distal end 190 of fastener 100 can be deformed to restrict movement of joining body 200 relative to fastener 100.

Additional features of fastener assembly 1000 are described with reference to FIG. 2 showing fastener assembly 1000 in a cutaway side view. Referring to FIG. 2, fastener 100 can include head 110 and extended section 120 extending from head 110. Extended section 120 can extend longitudinally from head 110 coextensively with longitudinal central axis 105. Extended section 120 can be symmetrically disposed about longitudinal central axis 105. According to one embodiment, fastener 100 can be of unitary one-piece construction. In one embodiment, head 110 and extended section 120 of fastener 100 can include longitudinal central axis 105 with extended section 120 being cylindrical in form and being formed symmetrically about longitudinal central axis 105. Head 110, in one embodiment, can be formed symmetrically about longitudinal central axis 105 and can have maximum diameter, D₂, larger than a maximum diameter, D₁, of extended section 120 in a preformed state. In one embodiment, the depicted maximum diameter, D₁, can be a uniform constant diameter of extended section 120 in a predeformed state. In one embodiment, the depicted maximum diameter, D₂, can be a uniform constant diameter of head 110. According to one embodiment, joining body 200 can be of unitary one-piece construction.

In another aspect, extended section 120 of fastener 100 can include distal end 190. Distal end 190, in one embodiment, can be defined by sidewall 191 forming cavity 192 provided, e.g., by a counterbore. Sidewall 191, which can be a circumferential sidewall, can be formed to be deformable so that when force is applied thereto, sidewall 191 deforms to increase a holding force between joining body 200 and fastener 100 and to secure a connection between joining body 200 and fastener 100. Distal end 190 defined by sidewall 191 forming cavity 192 can be configured to be more deformable than a remainder of extended section 120. Configured as described, distal end 190 of fastener 100 can be subject to deformation without a remainder of fastener 100 deforming and without joining body 200 deforming. Distal end 190 defined by sidewall 191 forming cavity 192 can be configured to have increased deformability relative to a remainder of extended section 120 of fastener 100. FIG. 2 illustrates fastener 100, including distal end 190 defined by sidewall 191 forming cavity 192 in a deformed state.

In a deformed state, sidewall 191 can be deformed to increase a holding force between joining body 200 and fastener 100. With sidewall 191 deformed, fastener 100 can restrict movement of joining body 200 relative to fastener 100. In one aspect, deformability of sidewall 191 can be controlled by controlling a thickness of sidewall 191. A deformability of sidewall 191 defining distal end 190 can be increased by decreasing a thickness of sidewall 191. A deformability of sidewall 191 defining distal end 190 can be decreased by increasing a thickness of sidewall. Different fastening applications may require different levels of deformability. In another aspect, a deformability of sidewall 191 can be controlled by material selection of fastener 100. In one aspect, deformability of distal end 190 defined by sidewall 191 forming cavity 192 can be controlled by a combination of a selected thickness of sidewall 191 and/or selected material of sidewall 191.

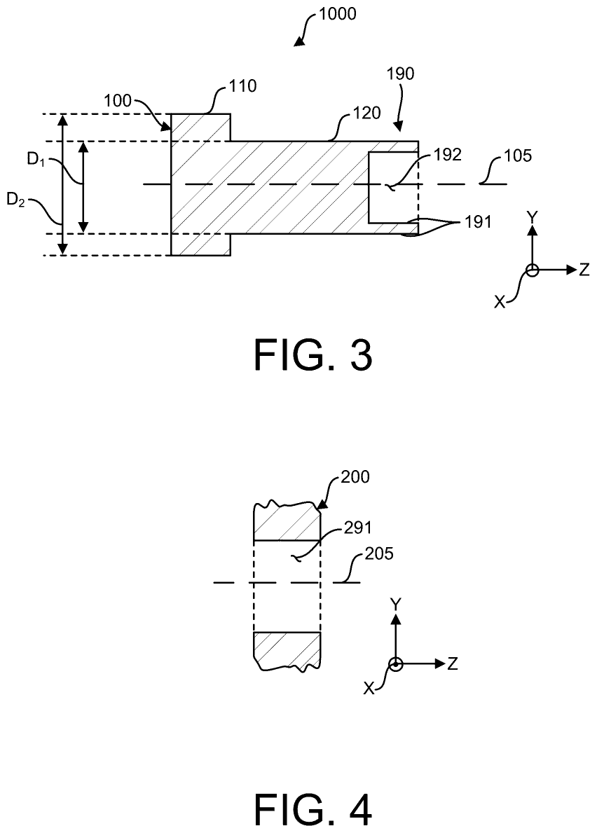

FIG. 3 illustrates a cutaway side view of fastener 100. Fastener 100 can include an enlarged head 110 and extended section 120 extending from head 110. Head 110 and extended section 120 of fastener 100 can include longitudinal central axis 105. Extended section 120 can define a cylinder that is symmetrically disposed about longitudinal central axis 105. Distal end 190 of extended section 120 can be defined by sidewall 191 forming cavity 192. Distal end 190 defined by sidewall 191 can be configured to be deformable so that when a force is applied to sidewall 191, sidewall 191 can deform to increase a holding force between joining body 200 and fastener 100 and to restrict movement of joining body 200 when the joining body 200 has been joined to fastener 100. In one embodiment, head 110 and extended section 120 can be defined by material that is symmetrically disposed about longitudinal central axis 105. In one embodiment, as indicated in FIG. 3, a length of extended section 120 can exceed a diameter, D₂, of head 110.

In FIG. 3, there is depicted a cross-sectional view of fastener 100 that includes head 110 and extended section 120 that extends from head 110. Extended section 120 can have a maximum diameter, D₁, less than a maximum diameter, D₂, of head 110. Distal end 190 of extended section 120 can be defined by a sidewall 191 forming cavity 192, e.g., provided by a counterbore. With cavity 192 formed, there can be defined distal end 190 and sidewall 191 that are subject to deformation to increase a holding force between joining body 200 and fastener 100 and to increase a holding force applied to zero or more secured members 300 between joining body 200 and fastener 100.

Fastener 100 having distal end 190 defining sidewall 191 forming cavity 192 can include a predeformed state and a deformed state. In a predeformed state, as shown in FIG. 3, distal end 190 of extended section 120 of fastener 100 can include a maximum outer diameter, D₁, in common with a diameter of extended section 120 between head 110 and distal end 190. In one embodiment as depicted in FIG. 3, extended section 120 in a predeformed state can include maximum outer diameter, D₁, that defines a constant uniform diameter for extended section 120 as depicted in FIG. 3.

In a deformed state as shown in FIG. 2, distal end 190 can include an expanded outer diameter, D_{A}, greater than a maximum, e.g., uniform constant diameter, D₁, of extended section 120 between head 110 and distal end 190 in a predeformed state (FIG. 3). In a deformed state, as shown in FIG. 2, distal end 190 can include an expanded outer diameter greater than a maximum diameter, e.g., D₁, of extended section 120 in a predeformed state (FIG. 3). In a deformed state, in one embodiment as shown in FIG. 2, distal end 190 can include an expanded outer diameter, D_{A}, greater than a uniform constant diameter of extended section 120 in a predeformed state (FIG. 3).

FIG. 4 is a cutaway side view of joining body 200 of fastener assembly 1000 according to one embodiment prior to being joined with fastener 100. Joining body 200 in the embodiment of FIG. 4 can be an arbitrary shape. Joining body 200 can include through hole 291 that permits joining body 200 to be fitted over extended section 120 of fastener 100 facilitating joining of joining body 200 on fastener 100. In FIG. 4, there is shown a cross-sectional view of joining body 200 having through hole 291. Through hole 291 can have a uniform constant diameter in one embodiment, as depicted in FIG. 4.

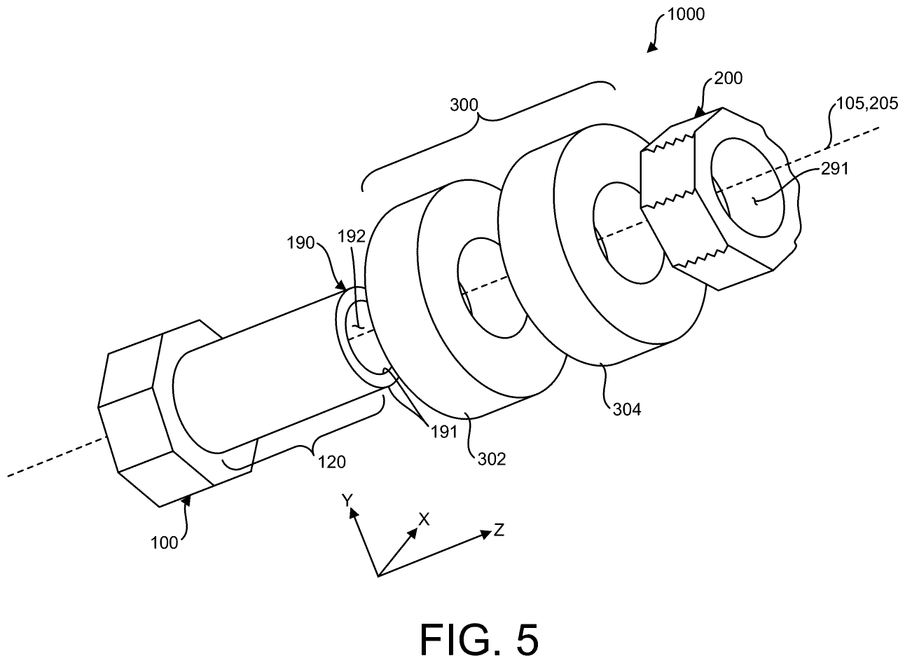

FIG. 5 is an isometric assembly view of fastener assembly 1000 having fastener 100 and joining body 200. As shown in FIG. 5, fastener assembly 1000 can include fastener 100 and joining body 200 which can be used to join zero or more secured members 300 as set forth herein. As shown in FIG. 5, an outer surface of sidewall 191 of extended section 120 can define a cylindrical shape. Sidewall 191 can define cavity 192 of extended section 120 which cavity 192 can provide a counterbore.

FIG. 5 is an exploded isometric view of fastener assembly 1000 including fastener 100 and joining body 200 which can be joined to fastener 100. On joining of joining body 200 to fastener 100, fastener assembly 1000 can be operational to secure in a fixed position zero or more secured members 300, which can include first member 302 and second member 304. In one embodiment, zero or more secured members 300 can include zero secured members. In one embodiment, zero or more secured members 300 can include one or more member. In one embodiment, zero or more secured members 300 can include two or more secured members.

Referring to the isometric view of FIG. 5, one or more of secured first member 302 and second member 304 can have functional elements thereon. For example, first member 302 and second member 304, in one embodiment, can define structures of a building (e.g., beams) or another structural apparatus.

In one embodiment, zero or more secured members can comprise zero members. In some embodiments, functional elements (e.g., building or other structural apparatus components) can be defined on joining body 200 and/or a fastener 100. In one embodiment, joining body 200 can have an arbitrary shape. In another embodiment, joining body 200, as set forth herein, can have the form factor of a fastener nut, e.g., hex nut or a square nut. In another embodiment, joining body 200 and/or fastener 100 can have an arbitrary form factor to define an arbitrary functional element.

As suggested by the isometric view of FIG. 5, fastener assembly 1000 can be configured so that when joining body 200 is joined to fastener 100 with fastener 100 in a predeformed state, a longitudinal central axis 105 of fastener 100 and a longitudinal central axis 205 of joining body 200 can be collocated.

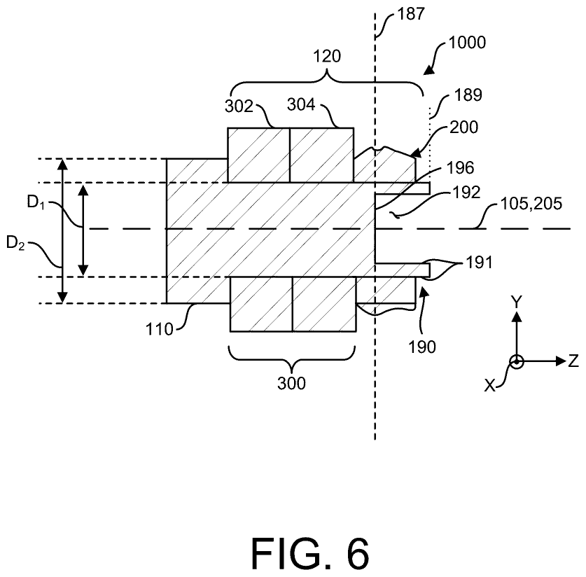

FIG. 6 is an assembly stage view of fastener assembly 1000 illustrating fastener assembly 1000 in an intermediary stage of assembly in which joining body 200 is fitted over extended section 120 of fastener 100 with fastener 100 in a predeformed state. Fastener 100 can include a predeformed state and a deformed state. FIG. 6 illustrates fastener 100 in a predeformed state, according to one embodiment.

In a predeformed state illustrated in FIG. 6, extended section 120 of fastener 100 can have a maximum diameter, D₁, which is small enough to permit joining body 200 to be fitted over and joined with fastener 100. In one embodiment, the maximum diameter, D₁, can be provided by a uniform constant diameter. In a predeformed state, distal end 190 of fastener 100 can have a maximum diameter, D₁, equal to a diameter of extended section 120 intermediate distal end 190 and head 110. Distal end 190, in one embodiment, can comprise elevations of extended section 120 between elevation 189 at a distal endpoint of extended section 120 and elevation 187 defined by a bottom surface 196 of cavity 192. Bottom surface 196 of cavity 192 can delimit cavity 192 formed by sidewall 191 defining distal end 190 and can extend perpendicular to longitudinal central axis 105 of fastener 100.

Referring to FIG. 6, distal end 190 of extended section 120 can be configured to be deformable so that distal end 190 can transition from a predeformed state as indicted in FIGS. 3, 5, and 6 into a deformed state as is indicated in FIG. 1 and FIG. 2. In a deformed state, distal end 190 can transition to exhibit a diameter, D_{A} (FIG. 2), greater than the maximum diameter, D₁, of distal end 190 in a predeformed state so that distal end 190 and specifically sidewall 191 defining distal end 190 to increase a holding force between joining body 200 and fastener 100 and to increase a holding force applied to any secured members 300 therebetween. Deforming distal end 190 can secure a connection between joining body 200 and fastener 100 and any secured members 300 therebetween.

Distal end 190 forming sidewall 191 in a deformed state, as shown in FIGS. 1 and 2, can resist and restrict axial direction movement of joining body 200 along longitudinal central axis 105 and longitudinal central axis 205 in a direction moving away from head 110. In another aspect, distal end 190 and sidewall 191 in a deformed state, as shown in FIG. 1 and FIG. 2, can resist and restrict rotational movement of joining body 200 about longitudinal central axis 105 and about longitudinal central axis 205 of joining body 200.

Referring to further aspects of joining body 200, joining body 200, in one embodiment, can include an arbitrary shape. In one embodiment, joining body 200 can include the form factor of a fastening nut to define the fastening nut which can be fastened with use, e.g., of a wrench or similar tool. In one embodiment, joining body 200 can be configured to be hand activated and can be configured as a hand twisted fastening nut. In one embodiment, joining body 200 can be provided by a commercial off-the-shelf (COTS) fastening nut. In one embodiment, joining body 200 provided by a fastening nut can include one or more custom feature to enhance the fastening operation of fastener assembly 1000.

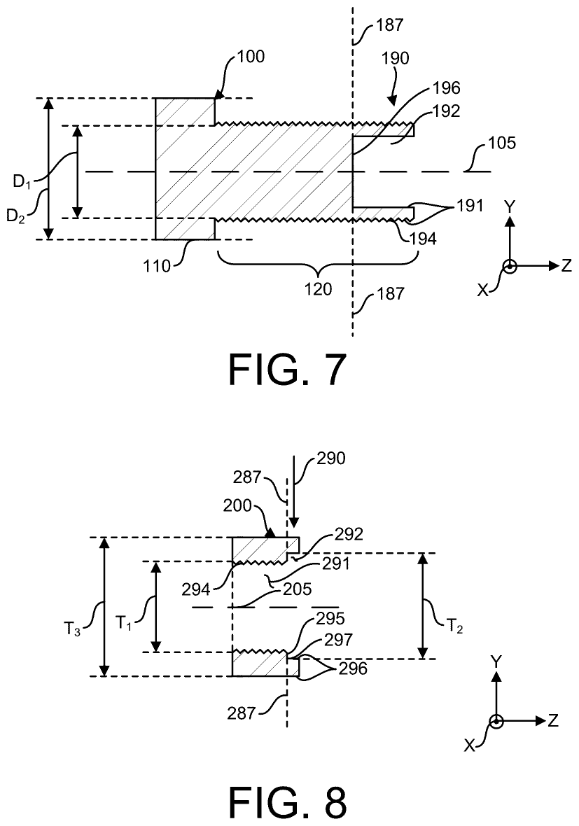

FIGS. 7-12 illustrate an alternative embodiment in which joining body 200 has custom features for improving fastening operation of fastener assembly 1000. As shown in FIGS. 7-12, fastener 100 and joining body 200 of fastener assembly 1000 can include respective mating threads 194 and mating threads 294 so that joining body 200 can be threaded for joining of joining body 200 to fastener 100 as shown in FIG. 7.

Referring to FIG. 7, fastener 100 can include head 110 and extended section 120 extending from head 110 with an exterior surface of extended section 120 having threads 194 formed thereon as shown. Extended section 120 can be cylindrical in shape with extended section 120 being symmetrically formed about longitudinal central axis 105 of fastener 100. Referring to FIG. 7, extended section 120 can include threads 194 as shown formed along a length of extended section 120 from head 110 to a distal end point of distal end 190 of extended section 120.

In a predeformed state as shown in FIG. 7, extended section 120 can feature a maximum diameter, D₁, provided by a uniform constant diameter throughout a length of extended section 120 such that a distal end 190 of extended section 120 has a maximum diameter, D₁, provided by a uniform constant diameter that is in common with a uniform constant diameter of a remainder of extended section 120 from head 110 to elevation 187 defined at a bottom surface 196 of cavity 192 which can be provided by a counterbore.

FIG. 8 illustrates a joining body 200 that can be used to join with fastener 100 as shown in FIG. 7. In the embodiment of FIG. 8, joining body 200 can include through hole 291 with an interior surface of joining body 200 having disposed thereon threads 294 for threading with threads 194 of extended section 120 of fastener 100 as shown in FIG. 7.

FIG. 7 shows a cross-sectional view of fastener 100 provided by a threaded fastener prior to the deformation of distal end 190 provided by cavity 192 forming a counterbore. FIG. 8 shows a cross-sectional view of joining body 200 provided by a threaded nut. FIG. 8 shows a cross-sectional view of joining body 200 provided by a threaded nut with cavity 292 forming an internal counterbore.

In another aspect, distal end 290 of joining body 200 in the embodiment of FIG. 8 can have formed therein a cavity 292 which can be provided by a counterbore. Cavity 292 which can be provided by a counterbore can be defined by bottom surface 295 extending perpendicularly with longitudinal central axis 205 of joining body 200 and interior surface 297. In the embodiment of FIG. 8, sidewall 296 with bottom surface 295 can delimit cavity 292, which can be provided by a counterbore. Sidewall 296 as depicted in FIG. 8 can be a circumferential sidewall. Referring to FIGS. 7 and 8, the features of fastener 100 including head 110, extended section 120, and sidewall 191 defining distal end 190 and forming cavity 192 can be symmetrically formed about longitudinal central axis 105. Similarly, the features of joining body 200 including through hole 291 defining cavity 292 can be symmetrically formed about longitudinal central axis 205. Fastener 100 can be of unitary single piece construction, and joining body 200 can be of unitary single piece construction.

Through hole 291 can include a first portion above (leftward) an elevation 287 of cavity 292 delimited by bottom surface 295 extending perpendicularly with longitudinal central axis 205 of joining body 200 and a second portion below (rightward) the elevation 287 of cavity 292 delimited by bottom surface 295 extending perpendicularly with longitudinal central axis 205 of joining body 200. The first portion can have a first inner diameter, T₁, and the second portion can have a second inner diameter, T₂. The first inner diameter, T₁, can be smaller than the second inner diameter, T₂. Joining body 200 can also have an outer diameter T₃.

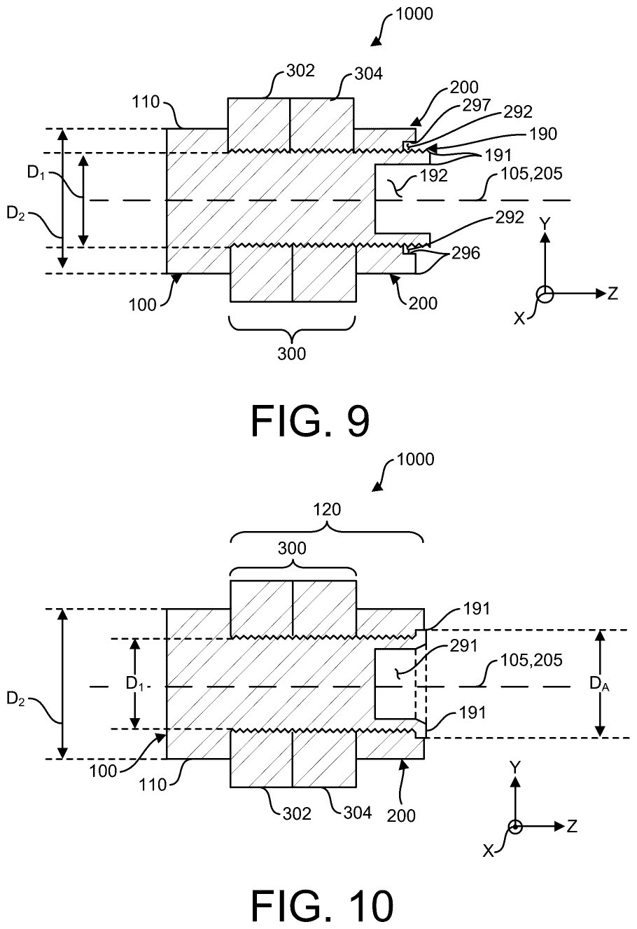

FIGS. 9 and 10 are assembly views of fastener assembly 1000 illustrating joining of joining body 200 to fastener 100. FIGS. 9 and 10 are cutaway side views illustrating assembly of fastener assembly 1000. Referring to FIG. 9, FIG. 9 shows joining body 200 threaded onto extended section 120 of fastener 100 to join joining body 200 to fastener 100. FIG. 9 illustrates fastener 100 in a predeformed state with extended section 120 of fastener 100 having a constant diameter throughout its length including throughout a length of distal end 190. With extended section 120 in a predeformed state having maximum diameter, D₁, provided by a constant outer diameter, joining body 200 can be threaded onto a distal end of extended section 120. The distal end 190 of fastener 100, in one embodiment, can be configured to have sufficient strength so that extended section 120 retains a maximum diameter D₁ defining a uniform constant diameter along its length when joining body 200 has been joined to fastener 100 by threading of joining body 200 onto fastener 100.

FIG. 10 illustrates distal end 190 of extended section 120 being transitioned into a deformed state to increase a holding force between joining body 200 and fastener 100. With a connection secured by deformation by fastener 100, distal end 190 and specifically sidewall 191 restricts movement of joining body 200 with respect to extended section 120. Movement that is restricted when connection between joining body 200 and fastener 100 is secured by deformation of fastener 100, as depicted in FIG. 10, can include axial movement in a direction of longitudinal central axis 205 and can include rotational movement (movement in a direction about longitudinal central axis 105 and longitudinal central axis 205 can also be restricted).

FIG. 10 is a side view of fastener assembly 1000, according to one embodiment, wherein fastener 100 is provided by a threaded fastener and wherein joining body 200 defining a mating component is provided by a threaded nut with counterbore. Fastener assembly 1000 as shown in FIG. 10 can join first and second components (first member 302 and second member 304) together in tight formation after extrusion of material from distal end 190 defined by sidewall 191 of fastener 100 into a cavity 292 of joining body 200 defined by a counterbore.

The presence of cavity 292 of joining body 200 can increase contacting surface friction forces between fastener 100 and joining body 200 relative to contacting surface friction forces between fastener 100 and joining body 200 in the absence of cavity 292. As shown in FIG. 10 with distal end 190 in a deformed state, a diameter of extended section 120 at distal end 190 can extend to exhibit diameter, D_{A}, wherein D_{A}>D₁, by the extrusion and deformation of material forming sidewall 191 to occupy cavity 292 as shown in FIG. 8.

Comparing the embodiment of FIG. 10 to the prior embodiment of FIG. 2, the presence of cavity 292 can increase the surface area of contacting surfaces of both fastener 100 and joining body 200 when joining body 200 is joined to fastener 100 and when distal end 190 of fastener 100 is transitioned into a deformed state as shown in FIG. 10 to increase a holding force between joining body 200 and fastener 100. In the deformed state as shown in FIG. 10, a maximum diameter of distal end 190 can be increased from diameter, D₁, to diameter, D_{A}, by material of sidewall 191 deforming and extruding outwardly to fill cavity 292.

Referring to FIG. 9 and FIG. 10, there is shown a fastener assembly 1000, according to one embodiment. Fastener assembly 1000 can include fastener 100 provided by a threaded fastener joining to joining body 200 provided by a threaded nut. Threading of joining body 200 onto fastener 100 to join joining body 200 onto fastener 100 can induce torquing force between fastener 100 provided by a threaded fastener and joining body 200 provided by a threaded nut to generate clamping forces between fastener and joining body 200 to thereby hold secured first member 302 and secured second member 304 in tight formation between head 110 of fastener 100 and joining body 200 provided by a threaded nut.

In order to restrict rotational movement of joining body 200 provided by a threaded nut relative to fastener 100 after proper torque and clamping forces are achieved, material of distal end 190 of fastener 100 defined by sidewall 191 forming cavity 192 provided by an internal counterbore can be deformed by force into cavity 292 provided by a counterbore of joining body 200 to define a deformed distal end 190. This deformed distal end 190 having material deformed and extruded into cavity 292 of joining body 200 can increase a holding force between joining body 200 and fastener 100 and any secured members 300 therebetween. This deformed distal end 190 having material deformed and extruded into cavity 292 of joining body 200 can provide for a mechanical lock for locking the joining body 200 provided by a threaded nut into position relative to the fastener 100 and prevent loosening of fastener assembly 1000.

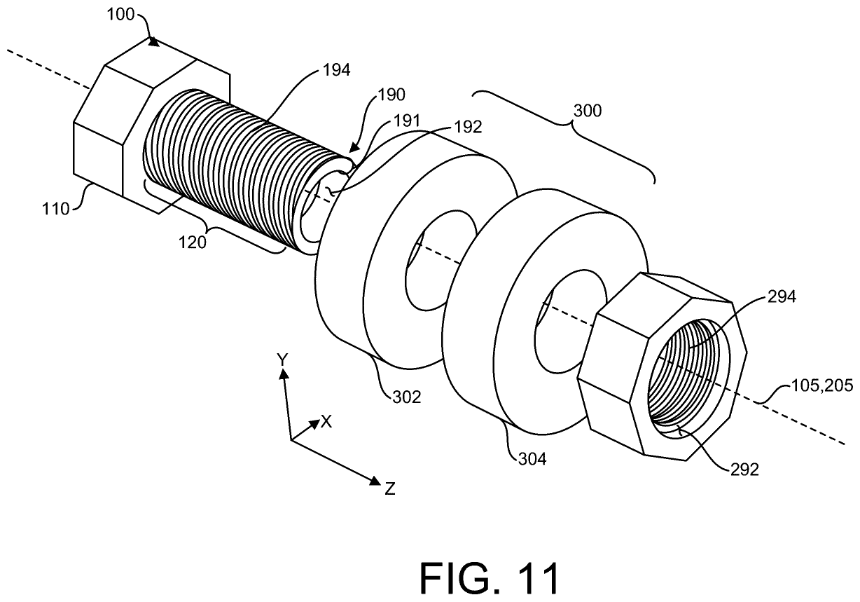

FIG. 11 is an exploded isometric view illustrating fastener assembly 1000. Referring to the isometric assembly view of FIG. 11, extended section 120 of fastener 100 can include external threads 194 formed on an external surface thereof. Extended section 120 can have the form of the cylinder formed symmetrically about longitudinal central axis 105 which can be collocated with longitudinal central axis 205 of joining body 200 when joining body 200 is joined to extended section 120 of fastener 100. Joining body 200 can have internal threads 294 configured for threading onto external threads 194 of fastener 100. For joining body 200 to extended section 120, joining body 200 can be threaded onto extended section 120. With extended section 120 threaded through joining body 200, a length of distal end 190 of extended section 120 can pass and protrude through elevation 287 (FIG. 8) of joining body 200 defined by bottom surface 295 delimiting cavity 292 of joining body 200.

With distal end 190 of fastener 100 in a predeformed state indicated as shown in FIG. 9, distal end 190 of fastener 100 can be subject to deformation so that material of sidewall 191, as shown in FIG. 7, extrudes to fill cavity 292 as shown in FIG. 10.

FIG. 10 shows fastener assembly 1000 of FIG. 9 in a fastened state. FIG. 10 is a side view of fastener assembly 1000 having fastener 100 provided by a threaded fastener and joining body 200, which may be of any configuration of a component with an internal threaded hole suitable to mate with fastener 100 upon inducing the proper torquing force between fastener 100 and joining body 200 to generate clamping forces between fastener 100 and joining body 200 to thereby clamp and hold secured first member 302 and secured second member 304 in tight formation therebetween.

Joining body 200 can include cavity 292 which can be provided by an internal counterbore for receipt of material defining distal end 190 of fastener 100 on deformation of fastener 100. FIG. 10 is a side view of fastener assembly 1000 where fastener 100 provided by a threaded fastener joins to a mating component provided by joining body 200 having internal threads and internal cavity 292 providing a counterbore to connect fastener assembly 1000 into tight formation on extrusion of material from distal end 190 of fastener 100 into a cavity 292 of joining body 200.

FIG. 11 shows an exploded perspective view of FIG. 10 prior to joining of joining body 200 to fastener and prior to deformation of distal end 190 of fastener 100 to secure a connection between joining body 200 and fastener 100. In the embodiment of FIG. 11, distal end 190 can deform internal to joining body 200 provided by a threaded nut having cavity 292 while still maintaining the thread locking properties of distal end 190 provided by deformation of distal end 190 as set forth herein.

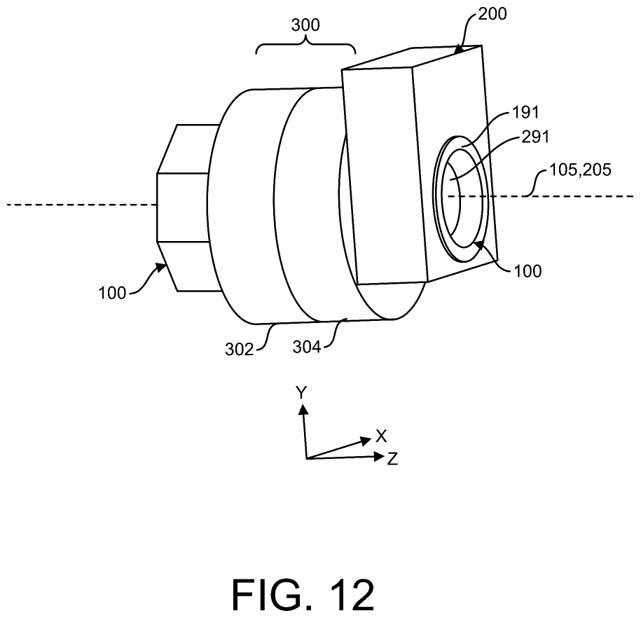

FIG. 12 illustrates an assembled view of fastener assembly 1000 as shown in FIG. 11. FIG. 12 is an isometric view of fastener assembly 1000 including fastener 100 and joining body 200, which can be provided by a mating threaded nut. Fastener assembly 1000 in the depicted view can hold secured first and second members 302 and 304 together in tight formation. Joining body 200 provided by a threaded nut can be tightened onto fastener 100 until proper torque and clamping forces are achieved. Distal end 190 forming cavity 192 provided by an internal counterbore of fastener 100 can then be deformed and extruded into cavity 292 provided by an internal counterbore of joining body 200 creating a deformed distal end that expands to expanded diameter, D_{A}. The described distal end 190 can be deformed to increase a holding force between joining body 200 and fastener 100 and to secure a connection between joining body 200 and fastener 100. Securing a connection between joining body 200 and fastener 100 can include deforming distal end 190 of fastener 100 to mechanically lock a position of joining body 200 relative to fastener 100. The described deformed distal end 190 can provide for a mechanical locking of joining body 200 provided by a threaded nut into position relative to fastener 100 provided by a threaded fastener and can prevent loosening of the fastener assembly 1000 defining a clamped assembly.

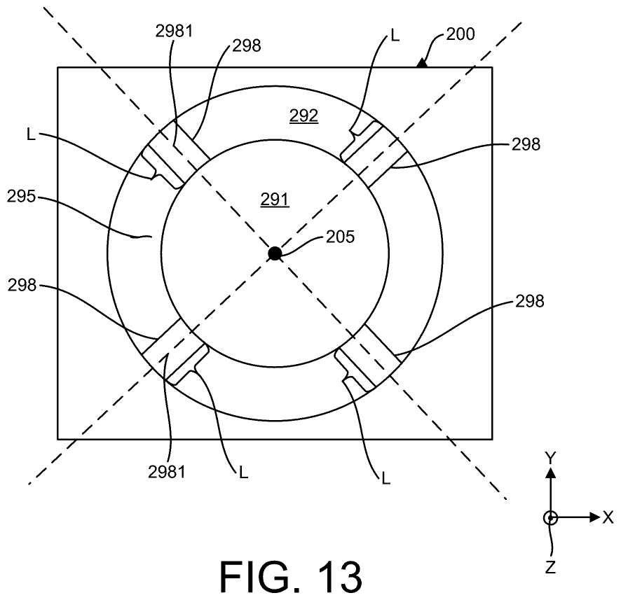

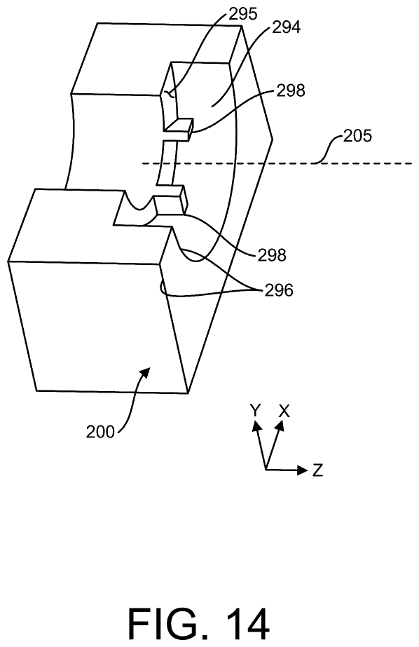

FIGS. 13 and 14 illustrate an alternative embodiment of joining body 200. The embodiment of joining body 200 as shown in FIGS. 13 and 14 is similar to the embodiment as shown in FIG. 11 and FIGS. 8-10, except that joining body 200 has the additional feature of ribs 298. As shown in FIGS. 13 and 14, bottom surface 295 of joining body 200 delimiting cavity 292, in one embodiment, can include ribs 298 which ribs 298 can be formed at circumferentially spaced apart locations on bottom surface 295 delimiting cavity 292 of joining body 200. For additional strength, ribs 298 can be contiguous and unitary with both bottom surface 295 of joining body 200, delimiting cavity 292, and interior surface 297 of sidewall 296 of joining body 200 delimiting cavity 292 as set forth in FIG. 8.

Surface 295, as shown in FIGS. 13 and 14, can be the shape of an annular ring from a top view (looking into bottom surface 295 in the direction of longitudinal central axis axis 205 parallel to the direction of the Z-axis of the depicted reference coordinate system) and ribs 298 can be formed at equally circumferentially spaced locations throughout surface 295 shown in the shape of an annular ring. There can be any number of ribs 298 formed on surface 295, e.g., 1 to N ribs (four ribs 298 are included in the depicted embodiment). Ribs 298, as best seen in FIG. 14, can have elongated top surfaces 2981 with lengths L having respective orientations pointing toward longitudinal central axis 205 of joining body 200. Ribs 298 can be operational to further increase the surface area of contacting surfaces of joining body 200 and fastener 100 when joining body 200 is joined to fastener 100 and when distal end 190 of fastener 100 is transitioned from a predeformed state as shown in FIG. 9 to a deformed state as shown in FIG. 10.

When distal end 190 is transitioned into a deformed state as shown in FIG. 10 and FIG. 12 to increase a holding force between joining body 200 and fastener 100 and to secure a connection between joining body 200 and fastener 100, ribs 298 can be operational to further restrict and resist rotational movement of joining body 200 about longitudinal central axis 205.

There is set forth herein, in one embodiment, a fastener assembly 1000 which, in one example, can be provided by a threaded fastener for joining two or more components together, and a joining body 200. A fastener 100, in one embodiment, can include a head 110, an extended section 120, and a counterbored portion of said extended section 120. A joining body 200, in one embodiment, can include an internally threaded mating nut with integral counterbore. A force can be applied for extruding material of the counterbored portion of the extended section 120 of fastener 100 into the counterbore of joining body 200.

There is set forth herein, according to one embodiment, a fastener assembly 1000 that comprises fastener 100 and joining body 200. Fastener 100 can be a threaded fastener for joining two or more components to be clamped together. Fastener 100, in one embodiment, can comprise a threaded fastener having a head and an external threaded extended section 120 defined by a sidewall 191 forming cavity 192. Cavity 192 can be provided by a counterbore formed internal to the threaded extended section 120 at the end of fastener 100 opposite the head 110 of fastener 100. Joining body 200 can be provided by an internally threaded mating nut with an integral cavity 292 provided by a joining body counterbore.

In one embodiment, after fastener 100 provided by a threaded fastener is joined and clamped together into joining body 200 provided by a mating threaded nut or mating component with internal thread, and the fastener 100 can be tightened to an acceptable torque level which creates proper clamping forces between the assembly. Subsequently, the distal end 190 of fastener 100 defining by sidewall 191 defining internally formed cavity 192 of fastener 100 can have a displacing extruding force applied to it in order to force material radially outward into cavity 292 of joining body 200 which can be provided by a counterbore of the mating threaded nut or mating component defining joining body 200.

This extruded material can cause fastener 100 to be mechanically locked to joining body 200 provided by the nut or component with internal thread, thereby resisting rotational movement of fastener 100 relative to joining body 200 and loosening of the fastener assembly 1000.

The extruded material of distal end 190 of fastener 100 may or may not extend beyond the end surface of joining body 200 provided by the threaded nut or the component with internal thread. The extruded material of distal end 190 of fastener 100 can be deformed into a cavity 292 of joining body 200 provided by counterbore. The counterbore and extruded material may take any shape.

For performing fastening action increase holding force between joining body 200 and fastener 100 and to secure a connection between joining body 200 and fastener 100 and any secured members 300 therebetween, distal end 190 of fastener 100 as shown throughout the views can be transitioned from a predeformed state into a deformed state in which material of sidewall 191 defining cavity 192 can extrude, e.g., radially outwardly to increase the diameter of distal end 190, e.g., to diameter, D_{A}.

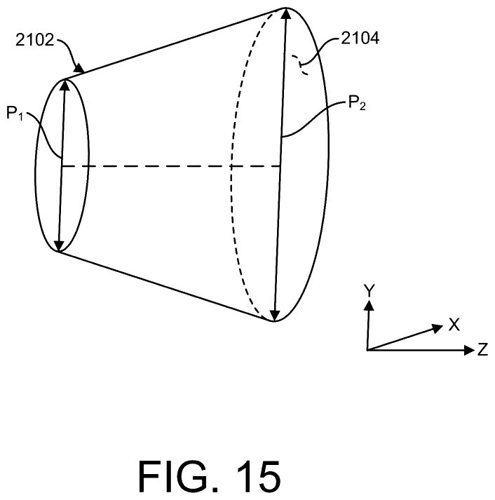

For performing of transitioning of distal end 190 from a predeformed state to a deformed state, a force can be applied to distal end 190 of fastener 100. In one embodiment, a conical punch 2102, as shown in FIG. 15, can be used to apply an appropriate force to distal end 190 of fastener with joining body 200 joined to fastener in an arrangement as set forth in FIG. 9. Conical punch 2102, as shown in FIG. 15, can have an increasing diameter from a distal end to a proximal end. In the embodiment of FIG. 15, conical punch 2102 can include a distal end diameter of P₁ and a proximal end diameter of P₂, wherein P₁<P₂. Conical punch 2102, as shown in FIG. 15, can include a distal end diameter, P₁, at a distal end thereof that is less than an inner diameter of distal end 290 of a joining body as shown in FIG. 8. Conical punch 2102 as shown in FIG. 15 can have a distal end diameter, P₁, at a distal end thereof that is less than an inner diameter of distal end 190 of extended section 120 of fastener 100 defined by sidewall 191 forming cavity 192. Conical punch 2102 can include a proximal end diameter, P₂, at a proximal end of conical punch 2102 that is greater than an inner diameter of a distal end 190 of extended section 120 of a fastener 100 defined by sidewall 191 forming cavity 192 which can be provided by a counterbore.

Accordingly for applying a force to distal end 190 to deform distal end 190, conical punch 2102 can be engaged to distal end 190 so that the distal end (smaller diameter) of conical punch 2102 extends into an interior of cavity 192 and so that a proximal end (larger diameter) of conical punch 2102 protrudes outwardly from distal end 190. Conical punch 2102, as shown in FIG. 15, can have a broad proximal surface 2104. With conical punch 2102 engaged with distal end 190, a force, e.g., a manually applied hammer force, can be applied to the conical punch 2102 at broad proximal surface 2104 generally in a direction of longitudinal central axis 105 and longitudinal central axis 205 toward head 110. With such force applied to conical punch 2102 with conical punch 2102 engaged to distal end 190, sidewall 191 can be forced outwardly so that material of sidewall 191 extrudes radially outwardly in the manner set forth herein to increase a holding force between joining body 200 to fastener 100 and to secure a connection of joining body 200 to fastener 100. With such force applied to conical punch 2102 with conical punch 2102 engaged to distal end 190, sidewall 191 can be forced outwardly so that material of sidewall 191 extrudes radially outwardly in a direction perpendicular to longitudinal central axis 105 and longitudinal central axis 205 so that material of sidewall 191 occupies cavity 292 of joining body.

Fastener assembly 1000 can be configured so that when a force in a direction of longitudinal central axis 105 is applied to conical punch 2102 with conical punch 2102 engaged with cavity 192 of fastener 100, conical punch 2102 can impart a radially directed force to sidewall 191 forming cavity 192 of fastener 100 so that material of sidewall 191 can extrude radially outwardly in a direction perpendicular to longitudinal central axis 105 and longitudinal central axis 205 resulting in material of sidewall 191 occupying cavity 292 of joining body 200.

With material of distal end 190 of fastener 100 extruded as described, movement of joining body 200 relative to fastener 100 can be restricted as set forth herein, by mechanically locking a position of joining body 200 relative to fastener 100. The described locking can restrict axial movement of joining body 200 relative to fastener 100 (in a direction coextensive with longitudinal central axis 105 and longitudinal central axis 205). The described locking can restrict rotational movement of joining body 200 relative to fastener 100 (in a direction about longitudinal central axis 105 and longitudinal central axis 205).

Materials forming fastener 100 can include metal, e.g., steel, copper, zinc, tin, bronze, brass, or aluminum. Materials forming joining body 200 can include metal, e.g., steel, copper, zinc, tin, bronze, brass, or aluminum. One or more of fastener 100 or joining body 200 can alternatively be formed of a non-metal material. Configuring distal end 190 of fastener 100 to be deformable can include controlling a material of distal end 190 be material selection and/or controlling a thickness of sidewall 191 defining distal end 190 by thickness selection. In one embodiment, fastener 100, which can have distal end 190 configured to be deformable, can be formed of metal having softness of about 4.0 or less on the Mohs scale. Configuring fastener 100 to be formed of a “soft” metal, e.g., having softness of about 4.0 or less on the Mohs scale, can facilitate the providing of fastener 100 to have distal end 190 that is easily deformable. In some applications, fastener 100 can have a softness of greater than 4.0, e.g., can be formed of hardened steel (about 7.0 or 8.0 on the Mohs scale), and deformability of distal end 190 can be tuned by controlling a thickness of sidewall 191. In one embodiment, fastener assembly 1000 can include fastener 100 formed of a first material having a first softness and joining body 200 formed of a second material having a second softness, wherein the first softness is less than the second softness. Fastener 100, in the described embodiment, can be of unitary single piece construction, and joining body 200 can be of unitary single piece construction. Providing fastener assembly 1000 so that fastener 100 is formed of softer material than joining body 200 can facilitate deformation of distal end 190 of fastener without deformation of joining body 200, e.g., to encourage the secure containing of material of distal end 190 of fastener 100 into cavity 292 of joining body 200 which can be provided by a counterbore. In some applications, fastener 100 can have a softness of about 4.0 or less on the Mohs scale and joining body 200 can be formed of hardened steel (about 7.0 or 8.0 on the Mohs scale).

In one embodiment, fastener 100, as set forth throughout the views, can be of unitary single piece construction. Fastener 100 can be formed, e.g., by casting or forging and can be formed of metal or non-metal. Similarly, joining body 200 can be of unitary, single piece construction. Joining body 200 can be formed, e.g., by casting or forging and can be formed of metal or non-metal.

Exemplary dimensions for fastener assembly 1000 are indicated in Tables A-E. In Tables A-E, the variable X is a scaling factor. In one embodiment X=1 cm. However, in alternative embodiments, X can range from about 1 mm or less to about 10 m or more. The overall length of fastener assembly 1000 can be arbitrary and selected in dependence on the criteria of the application. In one embodiment, fastener assembly 1000 can include the dimensions summarized in Table A.

TABLE A

| Element | Distance |
|---|---|
| D₁ | about 2.3X |
| D_{A} | about 2.6X |
| D₂ | about 3.5X |
| T₁ | about 2.3X |
| T₂ | about 2.6X |
| T₃ | about 3.5X |
| Sidewall 191 thickness | about 0.3X |
| Sidewall 296 thickness | about 0.5X |

In one embodiment, fastener assembly 1000 can include the dimensions summarized in Table B.

TABLE B

| Element | Distance |
|---|---|
| D₁ | about 2.3X ± 25% |
| D_{A} | about 2.6X ± 25% |
| D₂ | about 3.5X ± 25% |
| T₁ | about 2.3X ± 25% |
| T₂ | about 2.6X ± 25% |
| T₃ | about 3.5X ± 25% |
| Sidewall 191 thickness | about 0.3X ± 25% |
| Sidewall 296 thickness | about 0.5X ± 25% |

In one embodiment, fastener assembly 1000 can include the dimensions summarized in Table C.

TABLE C

| Element | Distance |
|---|---|
| D₁ | about 2.3X ± 50% or more |
| D_{A} | about 2.6X ± 50% or more |
| D₂ | about 3.5X ± 50% or more |
| T₁ | about 2.3X ± 50% or more |
| T₂ | about 2.6X ± 50% or more |
| T₃ | about 3.5X ± 50% or more |
| Sidewall 191 thickness | about 0.3X ± 50% or more |
| Sidewall 296 thickness | about 0.5X ± 50% or more |

In one embodiment, variations of fastener assembly 1000 can be practiced without reference to the relative scale of the various dimensional elements depicted in the drawings. In one embodiment, however, fastener assembly 1000 can be practiced in accordance with the relative scale of the various dimensional elements depicted in the drawings. The relative dimensions between the depicted elements can be scaled by the scaling factor, X, as set forth herein.

While this invention has been described in the specification and illustrated in the drawings with respect to a preferred embodiment, it is understood that all changes and modifications that come within the spirit of the invention are desired to be protected. Undoubtedly, many variations or equivalents may be substituted for elements of the invention such as various types of boltheads, thread characteristics, materials, or means for providing extruding forces by one having ordinary skill in the art to which the present invention most nearly pertains, and such variations are intended to be within the scope of the invention as disclosed herein.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Forms of the term “defined by” encompass relationships where an element is partially defined by as well relationships where an element is entirely defined by. Numerical identifiers herein, e.g. “first” and “second” are arbitrary terms to designate different elements without designation an ordering of elements. Methods, products and systems described as having a certain number of elements can be practiced with less than or greater than the certain number of elements. Furthermore, a device or structure that is configured in a certain way is configured in at least that way, but may also be configured in ways that are not listed.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

1. A fastener assembly comprising:
a fastener having an extended section that includes a deformable distal end;
a joining body having a through hole configured so that the extended section can be fitted through the through hole;
wherein the fastener is configured so that with the joining body joined to the fastener, the deformable distal end can be deformed to increase a holding force between the joining body and the fastener.

2. The fastener assembly of claim 1, wherein the extended section and the through hole are threaded so that the joining body can be threadably received on the extended section.

3. The fastener assembly of claim 1, wherein the extended section and a head of the fastener are symmetrically formed about a longitudinal central axis of the fastener.

4. The fastener assembly of claim 1, wherein the deformable distal end is defined by a circumferential sidewall that forms a counterbore.

5. The fastener assembly of claim 1, wherein the deformable distal end in a predeformed state has a first maximum diameter, wherein the deformable distal end is defined by a circumferential sidewall that forms a counterbore, wherein the circumferential sidewall is deformable so that in a deformed state the circumferential sidewall expands to define a second diameter, the second diameter larger than the first maximum diameter.

6. The fastener assembly of claim 1, wherein joining body includes a cavity, and wherein the fastener assembly is configured so that when the deformable distal end is deformed, material of the deformable distal end is received into the cavity.

7. The fastener assembly of claim 1, wherein joining body includes a counterbore, wherein the through hole of the joining body includes a first diameter and a second diameter at the counterbore, the second diameter being larger than the first diameter, and wherein the fastener assembly is configured so that when the deformable distal end is deformed, material of the deformable distal end is received into the counterbore.

8. The fastener assembly of claim 1, wherein the deformable distal end of the fastener is defined by a fastener counterbore that forms a circumferential sidewall, wherein joining body includes a joining body counterbore, wherein the through hole of the joining body includes a first diameter and a second diameter at the joining body counterbore, the second diameter being larger than the first diameter, and wherein the fastener assembly is configured so that when the deformable distal end is deformed, material of the circumferential sidewall is received into the joining body counterbore.

9. The fastener assembly of claim 1, wherein the deformable distal end of the fastener is defined by a circumferential sidewall that forms a fastener counterbore, wherein joining body includes a joining body counterbore, wherein the through hole of the joining body includes a first diameter and at the joining body counterbore a second diameter, the second diameter being larger than the first diameter, and wherein the fastener assembly is configured so that when the deformable distal end is deformed, material of the circumferential sidewall is received into the joining body counterbore, wherein at least one surface defining the joining body counterbore includes one or more rib for resisting rotational movement of the fastener relative to the joining body.

10. The fastener assembly of claim 1, wherein the deformable distal end of the fastener is defined by a circumferential sidewall that forms a fastener counterbore, wherein joining body includes a joining body counterbore, wherein the through hole of the joining body includes a first diameter and, at the joining body counterbore, a second diameter, the second diameter being larger than the first diameter, and wherein the fastener assembly is configured so that when the deformable distal end is deformed, material of the circumferential sidewall is received into the joining body counterbore, wherein a surface defining the joining body counterbore includes protruding therefrom a plurality of circumferentially spaced ribs configured for resisting rotational movement of the fastener relative to the joining body.

11. The fastener assembly of claim 1, wherein the fastener is of unitary single piece construction and formed of a first material, and wherein the joining body is of unitary single piece construction and formed of a second material, wherein a material softness of the first material is less than a material softness of the second material.

12. A method comprising:
fitting a through hole of a joining body over an extended section of a fastener that includes a head and the extended section, wherein the extended section includes a deformable distal end; and
with the joining body fitted over the extended section, deforming the deformable distal end to increase a holding force between the joining body and the fastener.

13. The method of claim 12, wherein the extended section and the through hole are threaded so that the joining body can be threadably received on the extended section.

14. The method of claim 12, wherein the deformable distal end is defined by a deformable circumferential sidewall that forms a counterbore.

15. The method of claim 12, wherein the extended section in a predeformed state has a first maximum diameter, wherein the deformable distal end is defined by a deformable circumferential sidewall that forms a fastener counterbore, wherein the deformable circumferential sidewall is deformable so that in a deformed state the deformable circumferential sidewall defines a second diameter, the second diameter larger than the first maximum diameter.

16. The method of claim 12, wherein joining body includes a counterbore, wherein the through hole of the joining body includes a first diameter and a second diameter at the counterbore, the second diameter being larger than the first diameter, and wherein the fastener and the joining body are configured so that when the deformable distal end is deformed, material of the deformable distal end is received into the counterbore.

17. The method of claim 12, wherein the deformable distal end of the fastener is defined by a fastener counterbore that forms a circumferential sidewall, wherein the joining body includes a joining body counterbore, wherein the through hole of the joining body includes a first diameter and, at the joining body counterbore, a second diameter, the second diameter being larger than the first diameter, and wherein the fastener and the joining body are configured so that when the deformable distal end is deformed, material of the circumferential sidewall is received into the joining body counterbore, and wherein the deforming the deformable distal end includes placing a conical punch into the fastener counterbore, and directing a force to the conical punch in a direction of a common longitudinal axis of the fastener and the joining body.

18. The method of claim 12, wherein the deformable distal end of the fastener is defined by a circumferential sidewall that forms a fastener counterbore, wherein the joining body includes a joining body counterbore, wherein the through hole of the joining body includes a first diameter and, at the joining body counterbore, a second diameter, the second diameter being larger than the first diameter, and wherein the fastener and the joining body are configured so that when the deformable distal end is deformed, material of the circumferential sidewall is received into the joining body counterbore, wherein at least one surface defining the joining body counterbore includes one or more rib for resisting rotational movement of the fastener relative to the joining body.

19. A fastener assembly comprising:
a fastener including a head and a threaded extended section that includes a deformable distal end defined by a circumferential sidewall that forms a counterbore, wherein the head, the threaded extended section and the circumferential sidewall are symmetrically formed about a longitudinal central axis of the fastener;
a joining body having a threaded through hole configured so that the threaded through hole can be threaded onto the threaded extended section of the fastener;
wherein the fastener is configured so that with the joining body joined to the fastener, the circumferential sidewall can be deformed to increase a holding force between the joining body and the fastener.

20. The fastener assembly of claim 19, wherein joining body includes a joining body counterbore, wherein the threaded through hole of the joining body includes a first diameter and, at the joining body counterbore, a second diameter, the second diameter being larger than the first diameter, and wherein the fastener assembly is configured so that when the deformable distal end of the fastener is deformed, material of the circumferential sidewall is received into the joining body counterbore.

21. The fastener assembly of claim 19, wherein joining body includes a joining body counterbore, wherein the through hole of the joining body includes a first diameter and a second diameter at the joining body counterbore, the second diameter being larger than the first diameter, and wherein the fastener assembly is configured so that when the deformable distal end is deformed, material of the circumferential sidewall is received into the joining body counterbore, wherein at least one surface defining the joining body counterbore includes one or more rib for resisting rotational movement of the fastener relative to the joining body.

22. A fastener comprising:
a head and an extended section extending from the head, wherein the extended section includes a deformable distal end;
wherein the deformable distal end is defined by a circumferential sidewall that forms a counterbore.

23. The fastener of claim 22, wherein the fastener is configured so that with a joining body joined to the fastener, the deformable distal end can be deformed to increase a holding force between the joining body and the fastener.

24. The fastener of claim 22, wherein the head and the extended section are symmetrically formed about a longitudinal central axis of the fastener.

25. The fastener of claim 22, wherein the extended section is symmetrically formed about a longitudinal central axis of the fastener, wherein the extended section includes threads formed along its length, and wherein the fastener is formed of unitary single piece construction.
